(19) United States
(12) Patent Application Publication
(10) Pub. No.: US 2026/0158534 A1
(43) Pub. Date: Jun. 11, 2026

(54) THREE-DIMENSIONAL WELL GROUP STRUCTURE FOR IN-SITU GROUNDWATER REMEDIATION

(71) Applicant: Chinese Research Academy of Environmental Sciences, Beijing (CN)

(72) Inventors: Fujun MA, Beijing (CN); Fanyang BU, Beijing (CN); Qingbao GU, Beijing (CN)

(21) Appl. No.: 19/287,881

(22) Filed: Aug. 1, 2025

(30) Foreign Application Priority Data
Dec. 10, 2024 (CN) 202411805870.6

(51) Int. Cl. B09C 1/00; C02F 1/70; C02F 1/72; C02F 101/30; C02F 103/06

(52) U.S. Cl. CPC B09C 1/002; C02F 1/70; C02F 1/725; B09C 2101/00; C02F 2101/306; C02F 2103/06

(57) ABSTRACT

The present application discloses a three-dimensional well group structure for in-situ groundwater remediation and an application method, relating to the technical field of groundwater remediation. The well group structure includes an air compressor, a PLC controller, a reagent dosing device, groundwater wells, and a groundwater pump. The well group structure and application method of the present application greatly improve the efficiency and effect of groundwater remediation. By adopting a unique cross 3D hydraulic circulation mode, not only a small hydraulic circulation is formed in the well itself, but also a large hydraulic circulation is formed between the well groups.

### CROSS-REFERENCE TO RELATED APPLICATIONS

This application claims priority to Chinese Patent Application 202411805870.6, filed on Dec. 10, 2024, the entire disclosure of which is incorporated herein by reference.

### TECHNICAL FIELD

The present application relates to the technical field of groundwater remediation, and specifically provides a three-dimensional well group structure for in-situ groundwater remediation and an application method thereof.

### BACKGROUND

In modern society, groundwater, as an important component of water resources, has increasingly attracted attention for the protection and remediation of its quality. Groundwater aquifers are vulnerable to various pollutants, leading to deterioration of water quality and posing a serious threat to the ecological environment and human health. Traditional groundwater remediation technologies mainly adopt high groundwater well injection technology to inject reagents into the groundwater aquifer for remediation when dealing with groundwater pollution.

Traditional groundwater remediation technologies have many limitations in aquifer pollution. Taking the common groundwater well injection technology as an example, the gap between injection wells is small, and the diffusion of reagents only depends on the diffusion under the action of concentration and water level pressure difference in the well. The diffusion effect is poor, the speed is slow and the distribution is uneven. The diffusion radius of reagents in a single well is extremely limited, usually only 3-5 meters. As a result, in a large polluted area, a large number of wells have to be intensively constructed to achieve effective remediation, which undoubtedly greatly increases the remediation cost and engineering complexity.

Especially in the scenario of chemical enterprises in production, due to the restrictions of building and complex underground pipeline layouts, when the aquifer under the building is polluted, it is very difficult to add reagents to this area. Traditional technologies are difficult to ensure that the reagents effectively diffuse to the core pollution area, and cannot give full play to the remediation role, resulting in the dilemma of groundwater remediation in such special areas, it is difficult to achieve the expected remediation goals, which seriously restricts the progress and effect of groundwater pollution control. Therefore, it is necessary to propose a three-dimensional well group structure and application method for in-situ groundwater remediation to solve the problems in the related art.

### SUMMARY

The objective of the present application is to make up for the deficiencies of the related art, and provide a three-dimensional well group structure and application method for in-situ groundwater remediation. It can pump water from the lower layer to the upper layer, pump water from the upper layer to the lower layer, and realize three-dimensional circulation between the well pipes themselves and adjacent well pipes, so that the reagent is fully mixed and contacted with the groundwater, efficiently removing organic pollutants in the groundwater and improving the remediation effect on the groundwater.

To solve the above technical problems, the present application provides the following technical solutions: a three-dimensional well group structure for in-situ groundwater remediation, which includes an air compressor, a programmable logic controller (PLC), a reagent dosing device, a groundwater well, and a submersible pump;
wherein the groundwater well is a special stainless-steel well pipe composed of double layers, and an inner layer is stainless steel with slits, an outer layer is a stainless-steel wire mesh structure, and a space between the inner layer and the outer layer is filled with crushed stones and quartz sand with a particle size of 2-3 mm; an entire well pipe is a water-permeable structure, a middle barrier is provided at the middle of the well pipe to divide the well pipe into an upper part, a middle part and a lower part, and the middle part of the well pipe is a water-impermeable structure;
the submersible pump comprises a pump body, the pump body is suspended in the groundwater well by a steel wire rope, a bottom end of the pump body is provided with a feed inlet, and the feed inlet is immersed in groundwater;
an outer surface of the pump body is provided with a water outlet pipe, one end of the water outlet pipe away from the pump body penetrates the middle barrier and extends to another side of the middle barrier;
an outer surface of the pump body is provided with a reagent dosing pipe, and a top end of the reagent dosing pipe is connected with the reagent dosing device, an upper surface of the pump body is fixedly connected with an air inlet pipe and an air outlet pipe, and top ends of both the air inlet pipe and the air outlet pipe are connected with the air compressor;
solenoid valves are provided inside the air inlet pipe and the air outlet pipe, and the solenoid valves are connected with the PLC controller through wires, and a piston is hermetically slid in the pump body, a spring is provided at a bottom of the piston, a hollow limit ring is provided on an inner wall of the feed inlet; and
an upper surface of the hollow limit ring is connected with a bottom end of the spring, a spherical ball is provided inside the hollow limit ring, and when the spherical ball is located at a bottom of the hollow limit ring, the hollow limit ring keeps sealing with an inner wall of the feed inlet.

In one embodiment, a slit width of the inner layer of the groundwater well is 0.5-1.5 mm, the slits are evenly distributed and a gap between adjacent slits is 5-10 mm, a mesh size of the stainless-steel wire mesh structure of the outer layer of the groundwater well is 1-3 mm, and the middle barrier is made of rubber with a thickness of 5-10 mm.

In one embodiment, the reagent dosing pipe is made of Polyvinyl Chloride (PVC) with an inner diameter of 3-5 mm, and a rubber sealing washer is provided at a connection part of the reagent dosing pipe and the pump body.

The present application also provides an application method of the three-dimensional well group structure for in-situ groundwater remediation as mentioned above, which includes:
S1. well group construction and equipment installation: determining positions and quantity of groundwater wells according to characteristics, scope, and hydrogeological conditions of a groundwater pollution area, and planning a layout to ensure full coverage and efficient treatment of the groundwater pollution area, and when excavating a well hole, strictly controlling a verticality error within ±0.5°, and a diameter of well hole to be adapted to a specification of the well pipe and comply with a construction standard;
S2. system debugging and parameter setting: comprehensively checking an equipment appearance, component connections, and electrical system, setting opening and closing of a solenoid valve of the reagent dosing device and a switching time of the solenoid valve of the submersible pump according to a pollution degree, pollutant characteristics, and treatment objectives, during a trial water pumping and reagent dosing, if a water pumping of the submersible pump is unstable, fine-tuning an opening time of the solenoid valve at an air inlet by 0.5 seconds each time until stable, so that a variation range of a pumping pressure is within ±0.1 MPa and an error of a reagent flow is within ±5%;
S3. groundwater circulation and purification treatment:
S301: starting the air compressor, submersible pumps of one group of groundwater wells pumping water from the lower layer and discharging from the upper layer, while another group pumping water from the upper layer and discharging from the lower layer, each pump accurately dosing reagents through the reagent dosing pipe according to a set rate; wherein the reagents are immediately mixed with the groundwater in the submersible pump, and in the same group of groundwater wells, the groundwater circulates between the upper and lower layers by a water permeability of the well pipe and a flow direction of inlet and outlet water, and due to changes in water level and water pressure, after water in the lower layer is pumped into the upper layer, part of the water diffuses to a surrounding area through a water-permeable part of the upper layer, and part of the water re-enters the pump for circulation, the water in the upper layer flows to the lower layer and then circulates similarly, to form a small hydraulic cycle in the well;
S302. between two groups of groundwater wells, the coordination of pumping from the upper layer and discharging to the lower layer and pumping from the lower layer and discharging to the upper layer constructs a large hydraulic cycle according to a water level difference, water flow inertia, and pumping power; the water discharged from the groundwater well that pumps from the lower layer and discharges to the upper layer flows horizontally to a water absorption area of the well that pumps from the upper layer and discharges to the lower layer, carrying reagents to seep into a stratum on the way; part of the groundwater enters the lower layer of the groundwater well that pumps from the lower layer and discharges to the upper layer and then undergoes upper pumping circulation; the water discharged from the lower layer of the groundwater well that pumps from the upper layer and discharges to the lower layer flows back horizontally in a reverse direction to the water absorption area of the well that pumps from the lower layer and discharges to the upper layer, seep into a surrounding stratum through the water-permeable structure, and part of the groundwater enters the upper layer for re-pumping circulation, in this process, the large cycle is nested with the small cycle, a horizontal water flow carries the reagents to diffuse horizontally, and the upper and lower layers alternately pump and discharge water to realize hydraulic cross-layer transfer, forming cross 3D hydraulic connections, so that the reagents are evenly diffused in gaps of a rock and soil between two wells and fully react with pollutants to purify the groundwater; and
S303. for special repair technical requirements, for the use of catalytic oxidation technology, injecting oxidation reagents into one group of groundwater wells and injecting catalytic reagents into another group of groundwater wells, controlling an injection rate to make the oxidation reagents and the catalytic reagents mix in a circulating water flow between the two wells according to the ratio of 1:0.5-1:2, and ensuring that the reagents efficiently react within a short time after contact to fully exert the catalytic oxidation effect to degrade pollutants; for the oxidation plus reduction technology to treat chlorinated hydrocarbons, first injecting reduction reagents into one group of groundwater wells for dechlorination biological reduction treatment, the treatment duration being set to 12-48 hours according to the pollution concentration, then injecting oxygen-rich clear water into the groundwater wells for 6-12 hours for cleaning to improve an oxidation-reduction potential, and then injecting slow-release oxidation reagents from another group of groundwater wells for oxidation treatment, wherein a release rate of the slow-release oxidation reagents is regulated at 0.01-0.1 g/h·m³ according to a remaining pollutant amount and stratum characteristics.
S4. water quality monitoring and system optimization: regularly collecting water samples to measure pollutant concentration, pH, dissolved oxygen, and conductivity indicators, and optimizing a system according to the results, and when the pollution does not meet the standard, analyzing reasons and then adjusting, if the reagents are not good, first testing and replacing in a small dose, observing the water quality for 1-2 days to decide whether to replace, and resetting the dosing rate when replacing, if an abnormal water flow affects the diffusion and circulation of the reagents, fine-tuning a pumping frequency of the submersible pump, and continuing to monitor and optimize until the water quality meets the standard to ensure the repair effect and the efficient and stable operation of the well group structure.

In one embodiment, in the step of well group construction and equipment installation, a gravel filter layer with a thickness of 0.3-0.5 m is first paved at the bottom of the well hole, then the pipe of the groundwater well is slowly placed vertically therein, the submersible pump is provided in the pipe of the groundwater well, stably suspended by a steel wire rope, a feed inlet is immersed in an appropriate depth of water, an air inlet pipe, an air outlet pipe, a reagent dosing pipe, the air compressor, the reagent dosing device, and the ground PLC are closely connected, each interface is tightly sealed, the air inlet and outlet pipes use 10-20 mm stainless-steel corrugated pipes, and 5-10 cm bentonite is filled between the well pipe and the well hole wall for reinforcement.

In one embodiment, in a horizontal water flow transfer of the large hydraulic cycle between the two groups of groundwater wells, considering the influence of water flow on the diffusion of reagents, a ratio of the pumping and discharging rates of the two wells is adjusted;
when the water flow rate is low, the pumping rate of the well that pumps from the upper layer is reduced and discharged to the lower layer and the pumping rate of the well that pumps from the lower layer is increased and discharged to the upper layer, to maintain the horizontal hydraulic gradient between the two wells within a range of 0.005-0.01 m/m, ensuring that the reagents fully diffuse to an area 20-30 m away from the well against the water flow resistance in a horizontal direction.

In one embodiment, in a link of hydraulic cross-layer transfer between the upper and lower layers, optimization is performed according to the characteristics of different stratum lithology, a sandy aquifer has large porosity and is conducive to a rapid penetration of water flow and reagents, the pumping frequency is set to once every 4-6 hours, while a silty clay aquifer has small porosity and low hydraulic conductivity, the pumping frequency to once every 8-10 hours is adjusted, and the pumping power is increased periodically by 10%-15% during a pumping process to make the reagents effectively break through the stratum resistance to realize cross-layer transfer, during a cross-layer transfer, if a reagent concentration in the upper layer is 30%-50% higher than that in the lower layer, the pumping parameters are automatically adjusted, the pumping of the upper layer is slowed down and the pumping of the lower layer by 10%-20% is accelerated, a concentration is balanced to promote a two-way uniform diffusion of the reagents, and a repair efficiency of 3D hydraulic connections is strengthened.

Compared with the related art, the three-dimensional well group structure and application method for in-situ groundwater remediation have the following beneficial effects:

The well group structure and application method of the present application significantly improve the efficiency and effect of groundwater remediation. By adopting a unique cross-3D hydraulic circulation mode, it not only forms a small hydraulic cycle within the well itself but also creates a large hydraulic cycle between well groups. The large hydraulic cycle is nested with small hydraulic cycles, involving both horizontal hydraulic transfer and cross-layer hydraulic transfer between upper and lower layers, such that the reagents is diffused more uniformly and broadly, the effective coverage radius is far beyond that of traditional single wells, the demand for the number of well groups is greatly reduced, and lowers construction and operation costs are reduced. It is suitable for remediation of polluted structures in complex scenarios such as gas stations, operating chemical enterprises, and roads in chemical parks.

Other advantages, objectives, and features of the present application will be described to some extent in the subsequent specification. To some extent, they will be obvious to those skilled in the art based on the examination of the following content, or can be learned from the practice of the present application.

### BRIEF DESCRIPTION OF THE DRAWINGS

In order to more clearly illustrate the technical solutions in the embodiments of the present application or the related art, the following briefly introduces the drawings required in the description of the embodiments or the related art. Obviously, the drawings described below are only some embodiments of the present application, and those skilled in the art can also obtain other drawings based on these drawings without creative efforts.

FIG. 1 is an application schematic diagram of a three-dimensional well group structure for in-situ groundwater remediation.

FIG. 2 is a three-dimensional structure schematic diagram of the submersible pump.

FIG. 3 is an internal structure schematic diagram of the submersible pump.

FIG. 4 is a partial structure schematic diagram of FIG. 3.

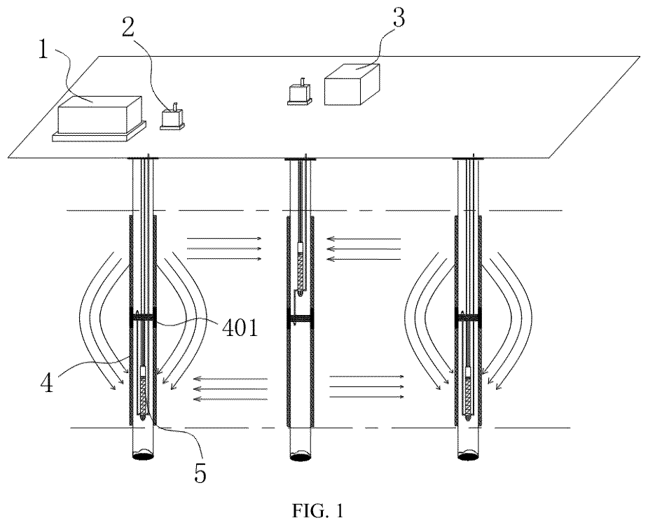

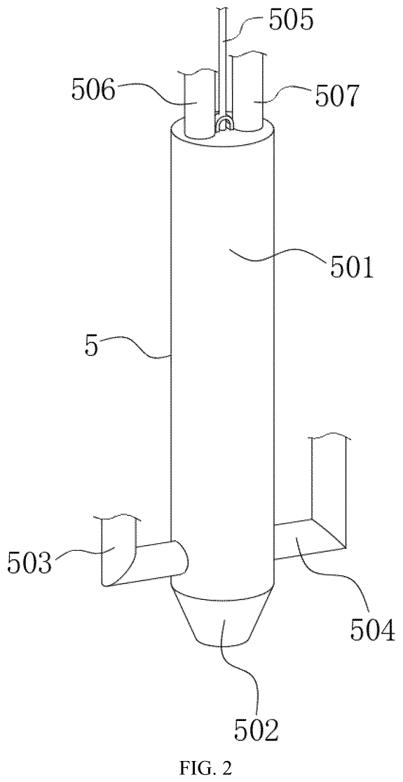

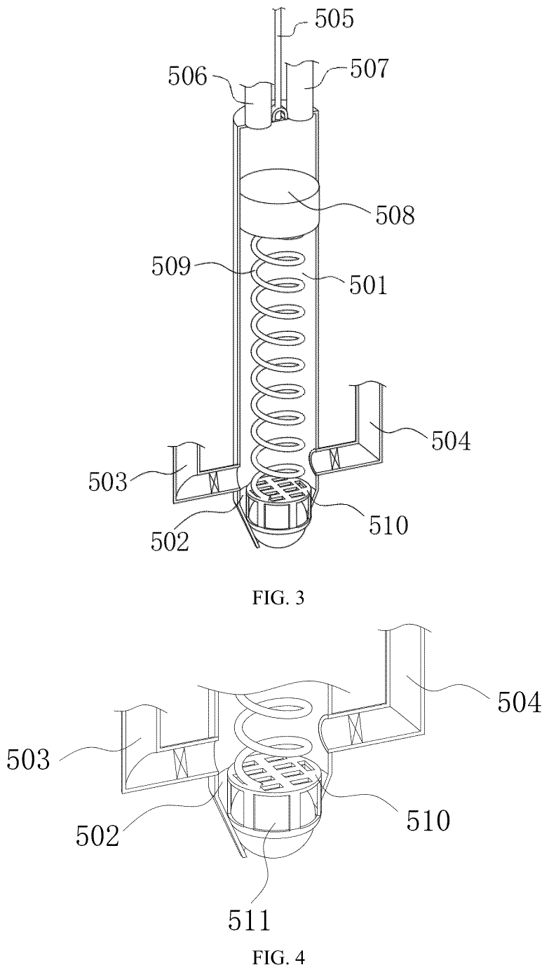

### DETAILED DESCRIPTION OF THE EMBODIMENTS

The technical solutions in the embodiments of the present application will be clearly and completely described below. Obviously, the described embodiments are only part of the embodiments of the present application, rather than all of them. Based on the embodiments of the present application, all other embodiments obtained by those skilled in the art without creative efforts shall fall within the protection scope of the present application.

### Embodiment 1

### Groundwater Pollution Remediation in a Small Factory Area

### Description of Application Scenario

Due to long-term chemical production activities, the underground soil and aquifer in the small factory area have suffered severe pollution. The polluted area is approximately 5,000 square meters, located below the production workshop and storage area, with a depth range from 5 meters to 15 meters below the surface. Pollutants include residual organic chemical raw materials (such as benzene series with a concentration of up to 5 mg/L, phenols with a concentration of about 3 mg/L), heavy metal ions (lead concentration reaching 0.2 mg/L, cadmium concentration 0.05 mg/L), and petroleum substances (petroleum hydrocarbon content about 8 mg/L). The pollution degree is uneven, and the pollutant concentration in some areas far exceeds environmental standards by several times. Due to surrounding dense buildings and crisscrossing underground pipelines, traditional remediation technologies are difficult to implement due to site restrictions. Not only is the remediation cost high (estimated to exceed 5 million yuan), but it also easily causes long-term interference with production operations. An efficient, precise, and low-site-disturbance remediation solution is urgently needed to ensure groundwater quality, reduce environmental risks, and ensure the factory's continuous compliant production and surrounding ecological safety.

A professional survey team used high-precision geological drilling equipment to analyze the geological structure and determine the characteristics and distribution of rock and soil layers. For example, the upper layer is silty clay with a thickness of 3-5 meters and a permeability coefficient of about 1×10⁻⁵ cm/s; the middle sand layer is 6-8 meters thick with a permeability coefficient of 5×10⁻³ cm/s; the lower clay rock is 4-6 meters thick with a permeability coefficient of 1×10⁻⁷ cm/s. The groundwater flow rate is accurately measured in the range of 0.05-0.15 m/d using an advanced groundwater flow rate and direction meter, with the flow direction being northeast. Water samples are collected at multiple points and analyzed by precision instruments such as an inductively coupled plasma mass spectrometer (ICP-MS) and gas chromatography-mass spectrometer (GC-MS) in the laboratory to accurately grasp key information such as pollutant types and concentration distribution. Based on this, considering the surrounding buildings, underground pipelines, and flow characteristics, 8 groundwater wells 4 are carefully designed and provided in a circular pattern at reasonable positions around the polluted area. The well gap is optimized to 20-30 meters according to hydrogeological parameters and pollution distribution, laying a foundation for subsequent precise remediation.

Drilling equipment is strictly selected according to the plan to accurately excavate well holes of appropriate depth. The verticality is controlled within ±0.5° using an advanced total station and inclinometer, and the diameter conforms to the well pipe specification. The special double-layer stainless-steel well pipe is slowly loared into the hole, and a 0.4-meter-thick gravel filter layer with a particle size of 3-5 mm is laid at the bottom. The submersible pump 5 is precisely provided in the upper layer of the well pipe, stably suspended by a high-strength corrosion-resistant steel wire rope 505, and the feed inlet is accurately determined to be 2-3 meters below the groundwater level. High-quality fluororubber sealing materials are used in each connection link to ensure tight and leak-free connections of the air inlet pipe 506, air outlet pipe 507, and reagent dosing pipe. The air compressor 1, reagent dosing device 3, and ground PLC controller 2 are seamlessly connected, and professional monitoring throughout the process ensured the well pipe verticality meet the standard.

Technicians comprehensively inspect and maintain the equipment. Based on previous surveys and treatment objectives, combining theoretical calculations and practical experience, the solenoid valve opening range of the reagent dosing device 3 is scientifically set to 25%-35%, and the dosing rate is set to 5-10 L/h according to pollutant concentration. The switching time range of the solenoid valves for the air inlet and outlet of the submersible pump 5 is precisely planned in the PLC controller 2 (air inlet: 4-5 seconds on, 9-11 seconds off; air outlet: 7-8 seconds on, 11-12 seconds off). Trial water pumping and reagent dosing are carried out, and the stability of pumping pressure and flow, and the accuracy of reagent dosing flow, are closely observed using high-precision pressure sensors and electromagnetic flowmeters. If the pumping pressure fluctuation exceeds ±0.1 MPa or the reagent flow error exceeded ±5%, the air inlet solenoid valve switching time is adjusted based on feedback data, with each adjustment accuracy reaching 0.1 second. After repeated optimization, the system is ensured to operate stably, precisely regulating the balance between reagent dosage and water flow power.

The air compressor 1 is started. The submersible pumps of one group of wells extract water from the lower layer and discharge it from the upper layer according to the program, while the other group does the opposite. After each pump accurately doses reagents, the reagents are immediately mixed with groundwater in the pump. In the same group of wells, groundwater circulates between the upper and lower layers through the water-permeable structure of the well pipe and water flow guidance. Taking the well that pumps the lower layer and discharges the upper layer as an example, after the lower-layer water is pumped to the upper layer by the pump, part of it diffuses tortuously through the upper-layer water-permeable structure, fully contacting the surrounding rock and soil to enhance reagent mixing; part of it [symbol] refluxes for recirculation, forming a stable small hydraulic cycle. When the upper-layer water flows to the lower layer, it is secondarily mixed near the pump suction port to strengthen the remediation efficiency. Specifically, the inner layer of the well pipe with 304 stainless-steel slits (slit width 1 mm, gap 8 mm), the outer-layer stainless-steel wire mesh (mesh size 2 mm), and the intermediate 2-3 mm crushed stone and quartz sand layer work together to guide the water flow in a turbulent state, making the reagent dispersion more uniform and increasing the chance of contact with pollutants.

A large hydraulic cycle is synergistically constructed between the two groups of wells. The water discharged from the well that pumps the lower layer and discharges the upper layer flowed horizontally to the water absorption area of the well that pumps the upper layer and discharges the lower layer, with reagents seeping into the stratum along the way, and part of the water enters the lower layer for circulation. The upper-layer drainage of the well that pumps the upper layer and discharges the lower layer refluxed in the reverse direction, seeps into the surrounding stratum through the water-permeable structure, and then enters the lower layer for re-pumping. In this process, the large cycle is nested with small cycles, the horizontal water flow carries reagents to diffuse up to 20-30 meters, and the upper and lower layers alternately pump and discharge water to achieve hydraulic cross-layer transfer, forming cross 3D hydraulic connections to ensure uniform dispersion of reagents in the rock and soil gaps for deep groundwater purification. In areas with fast water flow in the sand layer, the extraction and drainage rate is fine-tuned according to water flow rate monitoring data to maintain reagent concentration uniformity and circulation stability; in the silty clay layer, pulsed pressure is used to assist reagents in penetrating the stratum and enhance the remediation effect.

For complex organic pollutants, if catalytic oxidation technology is required, one group of wells is injected oxidation reagents (10%-15% hydrogen peroxide solution, dosing rate 3-5 L/h), and another group is injected catalytic reagents (iron-based catalyst concentration 0.5-1 g/L, dosing rate 2-3 L/h). The rates are precisely controlled to make the two mix in a 1:0.8 ratio in the circulating water flow between the two wells. For example, when treating benzene series pollution, oxidation and catalytic reagents rapidly react in the rock and soil pores and groundwater under the drive of water flow, degrading benzene series into harmless substances, with the reaction rate increasing by 60% compared to traditional single-reagent injection. When treating chlorinated hydrocarbons, reduction reagents (zero-valent iron dosage 10-15 g/L, lasting 24 hours) are first injected into one group of wells for dechlorination biological reduction, then oxygen-rich clear water (dissolved oxygen content 8-10 mg/L, flow rate 8-10 L/h) is injected for 8 hours for cleaning to improve the oxidation-reduction potential, and finally slow-release oxidation reagents (potassium permanganate slow-release particles, release rate 0.05 g/h·m³) are injected from another group of wells for oxidation treatment. The release rate is regulated according to stratum characteristics for continuous purification.

Water samples are regularly collected from the extraction wells, and indicators such as pollutant concentration, pH, and dissolved oxygen are accurately detected using professional equipment. After 3 months of operation, if local purification do not meet the standard, the causes are deeply analyzed, such as abnormal water flow or reagent failure, and the pump extraction frequency is adjusted, or suitable reagents are replaced and the dosing rate is reset. Through continuous monitoring and optimization, after system remediation, the groundwater pollutant concentration is significantly reduced. The benzene series concentration is dropped to below 0.1 mg/L, phenols to below 0.05 mg/L, heavy metal lead to within 0.01 mg/L, cadmium to below 0.002 mg/L, and petroleum hydrocarbons to meet the 0.5 mg/L standard. The water quality reached the industrial reuse standard, saving 800,000 yuan in water costs annually, reducing the risk of pollution discharge fines by 1.2 million yuan, reducing the hidden danger of soil pollution diffusion, protecting the surrounding ecology, enhancing the factory's environmental reputation, and helping to expand the market and sustainable development.

### Embodiment 2

### Local Groundwater Pollution Control in a Residential Community

A professional environmental monitoring team entered the residential community and used precision geophysical detection equipment and geological drilling technology to accurately determine the boundary and depth range of the polluted area, which is about 8 meters to 12 meters below the surface and covered an area of 3,000 square meters, located below the community greenery and some residential buildings.

Using advanced water quality analysis instruments to comprehensively detect water samples, the pollutants are identified as nitrogen and phosphorus nutrients (ammonia nitrogen concentration 2 mg/L, total phosphorus 0.5 mg/L) from domestic sewage leakage, trace organic detergents (anionic surfactant content 0.3 mg/L), and heavy metals (such as lead concentration 0.08 mg/L, cadmium concentration 0.02 mg/L) infiltrated from surrounding industrial activities. Combining the community building layout, underground pipeline diagram, and groundwater hydrological model, 6 groundwater wells 4 are scientifically planned and set at key nodes around and within the polluted area, provided in a grid pattern, taking into account both the remediation effect and the principle of minimal interference with residents'lives, ensuring comprehensive and effective control and circular treatment of polluted water.

Low-noise, small-volume professional drilling equipment is selected for construction, strictly controlling the well hole diameter and verticality. The special double-layer stainless-steel well pipe is placed in sequence, and a 0.35-meter-thick gravel filter layer with a particle size of 4-6 mm is laid at the bottom to prevent stratum from blocking the well pipe. The submersible pump 5 is precisely provided in the well pipe, reliably suspended by a high-strength, corrosion-resistant steel wire rope 505, and the feed inlet is accurately adjusted to an appropriate water level depth to ensure smooth and stable water intake. The air inlet pipe 506, the air outlet pipe 507, and the reagent dosing pipe are carefully connected, and food-grade silicone sealing washers are used to ensure airtight and watertight connections. The air compressor 1, reagent dosing device 3, and ground PLC controller 2 are seamlessly docked. The well pipe verticality is monitored by a laser guide throughout the construction, keeping the error stable within ±0.5° to ensure the stable and efficient operation of the system.

Technicians follow strict procedures to comprehensively detect the electrical performance of equipment, integrity of mechanical structures, and reliability of component connections. According to pollutant characteristics and environmental standards, an intelligent algorithm model is used to preliminarily set the opening and closing cycle of the solenoid valve of the reagent dosing device 3 to 5 minutes on and 10 minutes off, with a flow parameter of 3-6 L/h; the switching time logic of the solenoid valves of the submersible pump 5 is 3.5-4.5 seconds on and 8.5-9.5 seconds off for the air inlet, and 6.5-7.5 seconds on and 9.5-10.5 seconds off for the air outlet. The trial water pumping and reagent dosing program is started, and the system dynamics are real-time monitored by high-precision pressure sensors and electromagnetic flowmeters. If the pumping pressure fluctuation exceeds ±0.1 MPa or the reagent flow error exceeds ±5%, the switching time of the air inlet solenoid valve is fine-tuned based on feedback data, with each adjustment accuracy reaching 0.1 second. After repeated optimization, the system is ensured to operate stably, and the balance between reagent dosage and water flow power is precisely regulated.

The air compressor 1 is started. The submersible pumps of one group of wells efficiently extract groundwater from the lower layer, mix it with reagents, and discharge it from the upper layer, while another group operates in the reverse direction. Within the same group of wells, groundwater stably circulates between the upper and lower layers driven by the water-permeable structure of the well pipe and the water level difference. Taking the well that pumps the lower layer and discharges the upper layer as an example, after the lower-layer water is strongly pumped to the upper layer by the pump, part of it evenly diffuses through the stainless-steel wire mesh of the outer layer of the well pipe and the intermediate filling medium, fully interacting with the surrounding soil and groundwater through diffusion and osmosis to improve reagent dispersion and reaction probability; part of the water refluxes to the pump body for recirculation, forming local turbulent flow in the pump to strengthen reagent mixing and constructing an efficient small hydraulic circulation system. Specifically, the inner and outer layer structures of the well pipe and the filled crushed stone and quartz sand promote the water flow to alternate between laminar and turbulent states, enhancing the reagent diffusion effect and improving the remediation efficiency.

The two groups of wells cooperate synergistically to construct a strong hydraulic circulation network by virtue of the water level gradient, water flow inertia, and pumping power difference. The water discharged from the well that pumps the lower layer and discharges the upper layer carries reagents and flows radially to the water absorption area of the well that pumps the upper layer and discharges the lower layer, deeply interacting with strata of different permeability characteristics along the way, and part of the water enters the lower layer of the well that pumps the upper layer and discharges the lower layer to participate in the circulation; the upper-layer drainage of the well that pumps the upper layer and discharges the lower layer symmetrically refluxes to the upper layer of the well that pumps the lower layer and discharges the upper layer, penetrates the surrounding strata through the water-permeable structure, and then enters the lower layer for circulation, achieving effective horizontal diffusion of 20-30 meters and hydraulic cross-layer transfer driven by upper and lower layer alternation, forming cross 3D hydraulic connections to drive reagents to deeply purify the polluted water in the rock and soil pores between the two wells and degrade the pollutant concentration. In the case of local high-permeability areas in sandy soil layers, the pumping rate ratio is adjusted to maintain the horizontal hydraulic gradient at 0.008 m/m to ensure uniform reagent diffusion; in low-permeability clay layers, pulsed pumping periods are increased to promote reagent penetration into the strata and improve the remediation effect.

For heavy metal and organic composite pollution, a chemical precipitation-oxidation-reduction synergistic technology is adopted. A chelating agent (ethylenediaminetetraacetic acid disodium concentration 2-3 g/L, dosing rate 4-6 L/h) and a reducing agent (sodium sulfite concentration 5-8 g/L, dosing rate 3-5 L/h) are injected into one group of wells to precipitate heavy metal ions and partially reduce high-valent metals to low-valent states that are easy to precipitate; a Fenton's reagent-like strong oxidant (hydrogen peroxide concentration 8%-12%, ferrous sulfate concentration 2-3 g/L, mixed and dosed at a volume ratio of 5:1, rate 4-6 L/h) is injected into the other group of wells, and the oxidation reagent and reduction reagent are controlled to mix in a ratio of 2.5:1 in the circulating water flow. For example, in the treatment of lead-cadmium-organic chlorine composite pollution, the chelating agent captures lead and cadmium to form precipitates, the reducing agent reduces part of the high-valent chromium to precipitate, and the Fenton's reagent produces strongly oxidizing free radicals to degrade organic chlorine. After multiple cycles, the pollutant concentration is significantly reduced: ammonia nitrogen concentration is reduced to below 0.2 mg/L, total phosphorus to within 0.05 mg/L, anionic surfactant content to below 0.03 mg/L, heavy metal lead content to within 0.005 mg/L, cadmium content to below 0.001 mg/L, and the water quality is improved to reach above the secondary standard of water quality for domestic drinking water sources, ensuring the safety of residents'water use.

Well water samples are regularly collected according to specifications, and full-index analysis is carried out by high-precision equipment such as inductively coupled plasma mass spectrometry (ICP-MS) and gas chromatography-mass spectrometry (GC-MS). If monitoring finds that local water quality fluctuations do not meet the standard, rapid traceability and investigation are carried out. If the uneven stratum permeability leads to unbalanced reagent distribution, the pump frequency of the wells in the corresponding area is fine-tuned, and the extraction volume is increased or decreased by 10%-20% to improve the flow field; if the reagent precipitation blocks the stratum pores, an appropriate amount of acidic cleaning agent (hydrochloric acid concentration 0.5%-1%, injection volume 1-2 L) is injected in a pulsed manner to dredge, and the circulation remediation is restarted; if microbial growth affects the remediation, a bacteriostatic agent (chlorine dioxide concentration 0.2-0.3 mg/L, dosing volume 0.5-1 L/h) is dosed to control the flora, and the system is continuously and dynamically optimized to ensure that the groundwater stably meets the standard, restore the ecological function, and improve the living environment quality and residents'health and well-being in the community.

For those skilled in the art, it is obvious that the present application is not limited to the details of the above-described exemplary embodiments, and that the present application can be implemented in other specific forms without departing from the spirit or basic characteristics of the present application. Therefore, from any point of view, the embodiments should be regarded as exemplary and non-limiting. The scope of the present application is defined by the appended claims rather than the above description, and therefore it is intended to include all changes within the meaning and scope of the equivalents of the claims. Any reference signs in the claims should not be construed as limiting the claims involved.

What is claimed is:

1. A three-dimensional well group structure for in-situ groundwater remediation, comprising an air compressor, a programmable logic controller (PLC), a reagent dosing device, a groundwater well, and a submersible pump;
wherein the groundwater well is a special stainless-steel well pipe composed of double layers, and an inner layer is 304 stainless steel with slits, an outer layer is a stainless-steel wire mesh structure, and a space between the inner layer and the outer layer is filled with crushed stones and quartz sand with a particle size of 2-3 mm; an entire well pipe is a water-permeable structure, a middle barrier is provided at the middle of the well pipe to divide the well pipe into an upper part, a middle part and a lower part, and the middle part of the well pipe is a water-impermeable structure;
the submersible pump comprises a pump body, the pump body is suspended in the groundwater well by a steel wire rope, a bottom end of the pump body is provided with a feed inlet, and the feed inlet is immersed in groundwater;
an outer surface of the pump body is provided with a water outlet pipe, one end of the water outlet pipe away from the pump body penetrates the middle barrier and extends to another side of the middle barrier;
an outer surface of the pump body is provided with a reagent dosing pipe, and a top end of the reagent dosing pipe is connected with the reagent dosing device, an upper surface of the pump body is fixedly connected with an air inlet pipe and an air outlet pipe, and top ends of both the air inlet pipe and the air outlet pipe are connected with the air compressor;
solenoid valves are provided inside the air inlet pipe and the air outlet pipe, and the solenoid valves are connected with the PLC controller through wires, and a piston is hermetically slid in the pump body, a spring is provided at a bottom of the piston, a hollow limit ring is provided on an inner wall of the feed inlet; and
an upper surface of the hollow limit ring is connected with a bottom end of the spring, a spherical ball is provided inside the hollow limit ring, and when the spherical ball is located at a bottom of the hollow limit ring, the hollow limit ring keeps sealing with an inner wall of the feed inlet.

2. The three-dimensional well group structure for in-situ groundwater remediation according to claim 1, wherein a slit width of the inner layer of the groundwater well is 0.5-1.5 mm, the slits are evenly distributed and a gap between adjacent slits is 5-10 mm, a mesh size of the stainless-steel wire mesh structure of the outer layer of the groundwater well is 1-3 mm, and the middle barrier is made of rubber with a thickness of 5-10 mm.

3. The three-dimensional well group structure for in-situ groundwater remediation and the application method according to claim 1, wherein the reagent dosing pipe is made of Polyvinyl Chloride (PVC) with an inner diameter of 3-5 mm, and a rubber sealing washer is provided at a connection part of the reagent dosing pipe and the pump body.

4. An application method of the three-dimensional well group structure for in-situ groundwater remediation according to claim 1, comprising:
S1. well group construction and equipment installation: determining positions and quantity of groundwater wells according to characteristics, scope, and hydrogeological conditions of a groundwater pollution area, and planning a layout to ensure full coverage and efficient treatment of the groundwater pollution area, and when excavating a well hole, strictly controlling a verticality error within ±0.5°, and a diameter of well hole to be adapted to a specification of the well pipe and comply with a construction standard;
S2. system debugging and parameter setting: comprehensively checking an equipment appearance, component connections, and electrical system, setting opening and closing of a solenoid valve of the reagent dosing device and a switching time of the solenoid valve of the submersible pump according to a pollution degree, pollutant characteristics, and treatment objectives, during a trial water pumping and reagent dosing, if a water pumping of the submersible pump is unstable, fine-tuning an opening time of the solenoid valve at an air inlet by 0.5 seconds each time until stable, so that a variation range of a pumping pressure is within ±0.1 MPa and an error of a reagent flow is within ±5%;
S3. groundwater circulation and purification treatment:
S301: starting the air compressor, submersible pumps of one group of groundwater wells pumping water from the lower layer and discharging from the upper layer, while another group pumping water from the upper layer and discharging from the lower layer, each pump accurately dosing reagents through the reagent dosing pipe according to a set rate; wherein the reagents are immediately mixed with the groundwater in the submersible pump, and in the same group of groundwater wells, the groundwater circulates between the upper and lower layers by a water permeability of the well pipe and a flow direction of inlet and outlet water, and due to changes in water level and water pressure, after water in the lower layer is pumped into the upper layer, part of the water diffuses to a surrounding area through a water-permeable part of the upper layer, and part of the water re-enters the pump for circulation, the water in the upper layer flows to the lower layer and then circulates similarly, to form a small hydraulic cycle in the well;
S302. between two groups of groundwater wells, the coordination of pumping from the upper layer and discharging to the lower layer and pumping from the lower layer and discharging to the upper layer constructs a large hydraulic cycle according to a water level difference, water flow inertia, and pumping power; the water discharged from the groundwater well that pumps from the lower layer and discharges to the upper layer flows horizontally to a water absorption area of the well that pumps from the upper layer and discharges to the lower layer, carrying reagents to seep into a stratum on the way; part of the groundwater enters the lower layer of the groundwater well that pumps from the lower layer and discharges to the upper layer and then undergoes upper pumping circulation; the water discharged from the lower layer of the groundwater well that pumps from the upper layer and discharges to the lower layer flows back horizontally in a reverse direction to the water absorption area of the well that pumps from the lower layer and discharges to the upper layer, seep into a surrounding stratum through the water-permeable structure, and part of the groundwater enters the upper layer for re-pumping circulation, in this process, the large cycle is nested with the small cycle, a horizontal water flow carries the reagents to diffuse horizontally, and the upper and lower layers alternately pump and discharge water to realize hydraulic cross-layer transfer, forming cross 3D hydraulic connections, so that the reagents are evenly diffused in gaps of a rock and soil between two wells and fully react with pollutants to purify the groundwater; and
S303. for special repair technical requirements, for the use of catalytic oxidation technology, injecting oxidation reagents into one group of groundwater wells and injecting catalytic reagents into another group of groundwater wells, controlling an injection rate to make the oxidation reagents and the catalytic reagents mix in a circulating water flow between the two wells according to the ratio of 1:0.5-1:2, and ensuring that the reagents efficiently react within a short time after contact to fully exert the catalytic oxidation effect to degrade pollutants; for the oxidation plus reduction technology to treat chlorinated hydrocarbons, first injecting reduction reagents into one group of groundwater wells for dechlorination biological reduction treatment, the treatment duration being set to 12-48 hours according to the pollution concentration, then injecting oxygen-rich clear water into the groundwater wells for 6-12 hours for cleaning to improve an oxidation-reduction potential, and then injecting slow-release oxidation reagents from another group of groundwater wells for oxidation treatment, wherein a release rate of the slow-release oxidation reagents is regulated at 0.01-0.1 g/h·m³ according to a remaining pollutant amount and stratum characteristics;
S4. water quality monitoring and system optimization: regularly collecting water samples to measure pollutant concentration, pH, dissolved oxygen, and conductivity indicators, and optimizing a system according to the results, and when the pollution does not meet the standard, analyzing reasons and then adjusting, if the reagents are not good, first testing and replacing in a small dose, observing the water quality for 1-2 days to decide whether to replace, and resetting the dosing rate when replacing, if an abnormal water flow affects the diffusion and circulation of the reagents, fine-tuning a pumping frequency of the submersible pump, and continuing to monitor and optimize until the water quality meets the standard to ensure the repair effect and the efficient and stable operation of the well group structure.

5. The application method of the three-dimensional well group structure for in-situ groundwater remediation according to claim 4, wherein in the step of well group construction and equipment installation, a gravel filter layer with a thickness of 0.3-0.5 m is first paved at the bottom of the well hole, then the pipe of the groundwater well is slowly placed vertically therein, the submersible pump is provided in the pipe of the groundwater well, stably suspended by a steel wire rope, a feed inlet is immersed in an appropriate depth of water, an air inlet pipe, an air outlet pipe, a reagent dosing pipe, the air compressor, the reagent dosing device, and the ground PLC are closely connected, each interface is tightly sealed, the air inlet and outlet pipes use 10-20 mm stainless-steel corrugated pipes, and 5-10 cm bentonite is filled between the well pipe and the well hole wall for reinforcement.

6. The application method of the three-dimensional well group structure for in-situ groundwater remediation according to claim 4, wherein in a horizontal water flow transfer of the large hydraulic cycle between the two groups of groundwater wells, considering the influence of water flow on the diffusion of reagents, a ratio of the pumping and discharging rates of the two wells is adjusted;
when the water flow rate is low, the pumping rate of the well that pumps from the upper layer is reduced and discharged to the lower layer and the pumping rate of the well that pumps from the lower layer is increased and discharged to the upper layer, to maintain the horizontal hydraulic gradient between the two wells within a range of 0.005-0.01 m/m, ensuring that the reagents fully diffuse to an area 20-30 m away from the well against the water flow resistance in a horizontal direction.

7. The application method of the three-dimensional well group structure for in-situ groundwater remediation according to claim 4, wherein in a link of hydraulic cross-layer transfer between the upper and lower layers, optimization is performed according to the characteristics of different stratum lithology, a sandy aquifer has large porosity and is conducive to a rapid penetration of water flow and reagents, the pumping frequency is set to once every 4-6 hours, while a silty clay aquifer has small porosity and low hydraulic conductivity, the pumping frequency to once every 8-10 hours is adjusted, and the pumping power is increased periodically by 10%-15% during a pumping process to make the reagents effectively break through the stratum resistance to realize cross-layer transfer, during a cross-layer transfer, if a reagent concentration in the upper layer is 30%-50% higher than that in the lower layer, the pumping parameters are automatically adjusted, the pumping of the upper layer is slowed down and the pumping of the lower layer by 10%-20% is accelerated, a concentration is balanced to promote a two-way uniform diffusion of the reagents, and a repair efficiency of 3D hydraulic connections is strengthened.
